(19) United States
(12) Patent Application Publication
(10) Pub. No.: US 2018/0181940 A1
(43) Pub. Date: Jun. 28, 2018

(54) POS TERMINAL DEVICE, INFORMATION PROCESSING DEVICE, INFORMATION PROCESSING SYSTEM, IMAGE RECOGNITION METHOD, AND IMAGE RECOGNITION PROGRAM

(71) Applicant: NEC CORPORATION, TOKYO (JP)

(72) Inventors: Nozomu FUJIWARA, Tokyo (JP); KOTA IWAMOTO, Tokyo (JP); tetsuo inoshita, tokyo (JP); SOMA SHIRAISHI, TOKYO (JP); HIROSHI YAMADA, TOKYO (JP); JUN KOBAYASHI, TOKYO (JP); EIJI MURAMATSU, TOKYO (JP)

(21) Appl. No.: 15/129,299

(22) PCT Filed: Mar. 25, 2015
(86) PCT No.: PCT/JP2015/060301

§ 371 Date: Sep. 26, 2016

(30) Foreign Application Priority Data
Mar. 27, 2014 (JP) 2014-065285

(51) Int. Cl. G06Q 20/20; G07G 1/14

(52) U.S. Cl. CPC G06Q 20/208; G07G 1/145

(57) ABSTRACT

A POS terminal device is provided with: a memory unit for storing subject information in which a subject and specific information are associated; an imaging unit for imaging a subject and generating an image; and a specific information estimation unit for estimating, on the basis of the subject information, the specific information associated with the subject imaged by the imaging unit.

### CROSS-REFERENCE TO RELATED PATENT APPLICATIONS

This application is a National Stage Entry of International Application No. PCT/JP2015/060301, filed Mar. 25, 2015, which claims priority from Japanese Patent Application No. 2014-065285, filed Mar. 27, 2014. The entire contents of the above-referenced applications are expressly incorporated herein by reference.

### TECHNICAL FIELD

The present invention relates to a POS terminal device, an information processing apparatus, an information processing system, an image recognition method, and an image recognition program.

### BACKGROUND ART

In a general merchandising store such as a supermarket, a label which indicates identification information representing such as, e.g., a discounted product (hereinafter referred to as a discount label) is adhered to the product in a case where the identification information is to be indicated. An operator of a POS (Point Of Sales) terminal device visually confirms the discount label adhered to the product when the product is checked out, and the operator can determine that the product in question is a discounted item.

In recent years, a technique, for using an image sensor such as a CCD (Charge Coupled Device) camera provided in a POS terminal device to capture images of a product and the discount label and generate images to recognize the product and the discount label, has attracted attention.

For example, PTL 1 describes a POS terminal device capturing an image of an object and recognizing the captured image as the product. This POS terminal device previously stores a PLU (Price Lookup) file in which an image of a product and information about a price and the like of the product are associated with each other. The POS terminal device manages sales of each product by identifying a captured product based on information about the product held in the PLU file with the captured image of the product.

PTL 2 describes a product information reading apparatus recognizing a service label (discount label) adhered to a product. The product-information-reading-apparatus previously stores label feature data, i.e., data of the service label, into a POS terminal device. The product-information-reading-apparatus recognizes the service label adhered to the product by determining, based on the captured service label and the label feature data, product information with recognition processing such as pattern recognition and OCR (Optical Character Recognition).

### CITATION LIST

### Patent Literature

[PTL 1] Japanese Patent No. 5132732

[PTL 2] Japanese Patent Laid-Open No. 2012-94073

### SUMMARY OF INVENTION

### Technical Problem

In the technique for recognizing, e.g., a product and a service label and adhered to the product based on the image of the product, it is necessary to improve a recognition rate so as to reduce an error in a recognized result.

In the technique described in PTL 1, a captured product is identified based on the PLU file held in advance by the POS terminal device. However, the technique described in PTL 1 only discloses a technique for identifying a captured product on the basis of the PLU file held in advance by the POS terminal device, and there is a problem in that the improvement of the recognition rate is not taken into consideration.

In PTL 2, for example, when a service label is peeled off from a product and the product does not have the service label adhered thereto even though the product is originally a discount target product, it is difficult for the product-information-reading-apparatus described in PTL 2 to recognize that the product is a discounted item.

Therefore, an object of the present invention is to provide a POS terminal device capable of improving a recognition rate of the product upon repeated use and capable of estimating a service label that had been adhered to a product, by capturing an image of the product, even in a case where the service label is peeled off.

### Solution to Problem

A POS terminal device according to the present invention includes a storage unit storing subject information in which a subject and identification information are associated with each other, an image capturing unit capturing an image of the subject and generating the image, and an identification information estimation unit estimating, on the basis of the subject information, the identification information associated with the subject, the image of which has been captured by the image capturing unit.

An information processing apparatus according to the present invention includes a storage unit storing subject information in which a subject and identification information are associated with each other, and an identification information estimation unit receiving an image of the subject and estimating, on the basis of the subject information, the identification information associated with the subject.

An information processing system according to the present invention includes the POS terminal device according to the present invention, and an information processing apparatus, wherein the POS terminal device further includes a communication unit transmitting and receiving the subject information to and from the information processing apparatus.

An information processing system according to another aspect of the present invention includes a POS terminal device including an image capturing unit capturing an image of a subject and generating the image, and an information processing apparatus, wherein the information processing apparatus includes a storage unit storing subject information in which the subject and identification information are associated with each other, and an identification information estimation unit estimating, on the basis of the subject information, the identification information associated with the subject, the image of which has been captured.

An image recognition method according to the present invention includes capturing an image of a subject and generating the image and estimating, on the basis of subject information held by a storage unit, identification information associated with the subject the image of which has been captured.

An image processing program according to the present invention causes a computer to operate as storage means storing subject information in which a subject and identification information are associated with each other, image capturing means capturing an image of the subject and generating the image, and identification information estimation means estimating, on the basis of the subject information, the identification information associated with the subject the image of which has been captured by the image capturing unit.

### Advantageous Effects of Invention

According to the present invention, a recognition rate of the product is improved upon repeated use, and a service label that had been adhered to a product can be estimated by capturing an image of the product even in a case where the service label is peeled off.

### BRIEF DESCRIPTION OF DRAWINGS

FIG. 1 is a block diagram illustrating an example of a connection between a server and a POS terminal device according to a first exemplary embodiment of the present invention.

FIG. 2 is a schematic diagram illustrating a POS system according to the present invention.

FIG. 3 is a flowchart illustrating an example of processing of the POS terminal device according to the first exemplary embodiment of the present invention.

FIG. 4 is a block diagram illustrating a product identifying unit of the POS terminal device according to the second exemplary embodiment of the present invention.

FIG. 5 is a flowchart illustrating a flow of processing of the product identifying unit according to the second exemplary embodiment of the present invention.

FIG. 6 is a block diagram illustrating a configuration of the POS terminal device and a server according to the third exemplary embodiment of the present invention.

FIG. 7 is a flowchart illustrating a flow of processing of the POS terminal device and the server according to the third exemplary embodiment of the present invention.

FIG. 8 is a block diagram illustrating a configuration of the POS terminal device according to the fourth exemplary embodiment of the present invention.

FIG. 9 is a flowchart illustrating a flow of processing of the POS terminal device according to the fourth exemplary embodiment of the present invention.

FIG. 10 is a block diagram illustrating a flow of image recognition according to the present invention.

FIG. 11 is a flowchart illustrating a flow of an image recognition method according to the present invention.

### DESCRIPTION OF EMBODIMENTS

Modes for carrying out the present invention will be hereinafter explained in details with reference to drawings as necessary.

### 1. Configuration of POS Terminal Device

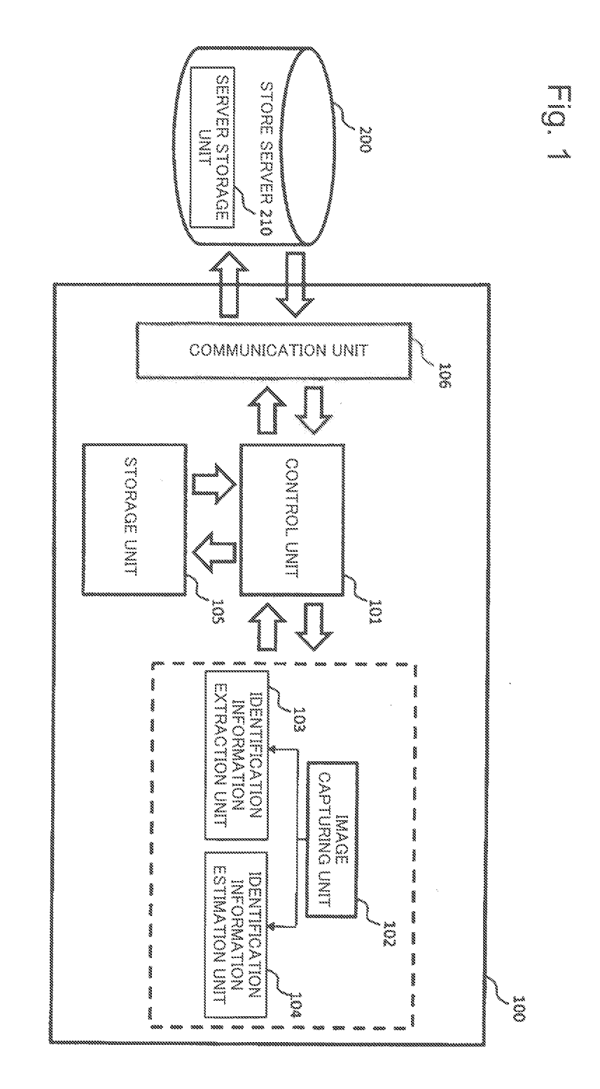

FIG. 1 is a block diagram illustrating an example of a POS terminal device 100 according to a first exemplary embodiment of the present invention and a server 200. The POS terminal device 100 according to the present invention includes a control unit 101, an image capturing unit 102, an identification information extraction unit 103, an identification information estimation unit 104, a storage unit 105, and a communication unit 106. The server 200 includes a server storage unit 210. The POS terminal device 100 is connected to the server 200 via the communication unit 106.

First, each unit constituting the POS terminal device 100 will be explained. The control unit 101 is, for example, a CPU (Central Processing Unit), and can control processing executed by the POS terminal device 100. More specifically, the control unit 101 controls processing of the image capturing unit 102, the identification information extraction unit 103, the identification information estimation unit 104, and the like.

The image capturing unit 102 can capture an image of a subject. The POS terminal device 100 according to the present invention is installed in a store and the like. The subject is, for example, a product bought and sold in the store and the like. The image capturing unit 102 has a function of capturing an image of a product and generating an image of the product. In the following explanation, the subject is explained as a product bought and sold in the store and the like, but the subject is not limited to a product.

The identification information extraction unit 103 can extract identification information from an image of a product. The image of the product may be an image generated by the image capturing unit 102, or may be an image input by an external device and the like. In a case where the POS terminal device 100 is installed in a store and the like, the identification information is, for example, a discount label indicating the product bought and sold in the store and the like, is a discounted item. The identification information extraction unit 103 extracts an image of the discount label from the image of the product, and generates subject information in which the product and the discount label are associated with each other. In a case where the identification information extraction unit 103 is unable to extract the image of the discount label from the image of the product, the identification information extraction unit 103 generates subject information indicating that any discount label is not adhered to the product (the product is not a discounted item). Further, the identification information extraction unit 103 stores the generated subject information to the storage unit 105. At this occasion, instead of storing the subject information to the storage unit 105, the identification information extraction unit 103 may store the subject information to the server storage unit 210 provided in the server 200. In this case, the identification information extraction unit 103 stores the subject information into the server storage unit 210 via the communication unit 106. In the following explanation, the identification information is explained as an image of a discount label, but the identification information is not limited to an image of a discount label.

The identification information estimation unit 104 can estimate the discount label associated with the product captured by the image capturing unit 102, based on the subject information stored in the storage unit 105. In a case where different kinds of discount labels are associated with the same product, the identification information estimation unit 104 estimates that one of the discount labels, the total number of which are stored in the storage unit 105 is the largest, is the possible discount label associated with the product. The identification information estimation unit 104 may estimate the discount label associated with the product captured by the image capturing unit 102, based on the subject information stored in the server storage unit 210. At this occasion, the identification information estimation unit 104 may estimate the discount label from all the subject information stored in the storage unit 105, or may estimate the discount label from the subject information generated by the image capturing unit 102 within a predetermined period of time. It should be noted that the predetermined period of time can be set freely by a user.

Generally-available image processing such as pattern recognition can be used for collation between the image captured by the image capturing unit 102 and the subject information. More specifically, the identification information estimation unit 104 estimates the discount label adhered to the product based on the image of the product, not from the discount label. Therefore, even in a case where the discount label is not adhered to the product captured by the image capturing unit 102, the identification information estimation unit 104 can estimate the discount label associated with the product. Further, for example, even when not only the image captured by the image capturing unit 102 is a partial image of the product, but the image held by the storage unit 105 is an entire image of the product, the identification information estimation unit 104 can estimate the identification information associated with that product. This is because the identification information estimation unit 104 compares the feature quantities of the two images, and when a feature quantity of the partial image of the product and a feature quantity of a part of the entire image of the product are similar to each other within a predetermined range, the two products can be determined to be the same.

In this case, when a discount label is not adhered to a discounted item because of a mistake and the like caused by the store side, it may possibly occurs in the identification information extraction unit 103 that it generates subject information different from an exact information which should be generated for the product. However, the identification information extraction unit 103 generates subject information every time the image capturing unit 102 generates an image. Therefore, as the image capturing unit 102 repeats image capturing of the same product, the total number of pieces of axact subject information of the product becomes relatively more than the total number of pieces of incorrect subject information. More specifically, when different kinds of pieces of subject information are associated with the same product, the identification information estimation unit 104 estimates the discount label based on the subject information, the total number of pieces of which are stored in the storage unit 105 is the largest, and therefore, the chance of estimating the incorrect subject information is low. Therefore, the recognition rate of the product of the identification information estimation unit 104 is improved as the image capturing unit 102 repeats image capturing.

The storage unit 105 stores subject information. For example, an HDD (Hard Disk Drive), an SSD (Solid State Drive), and the like can be used as the storage unit 105.

The communication unit 106 is a communication interface for connecting the POS terminal device 100 and the server 200. The communication unit 106 may be a wired LAN (Local Area Network) or may be a wireless LAN. The POS terminal device 100 can connect to an external server and the like via the communication unit 106.

The server 200 is connected to multiple POS terminal devices, and is, for example, a store server installed in a store and the like. The server 200 includes a server storage unit 210 storing subject information received from each POS terminal device. The server storage unit 210 stores all the subject information held by each POS terminal device connected to the server 200. Hereinafter, a network in which each POS terminal device and the server 200 are connected will be explained.

### 2. Connection Between POS Terminal Device and Server

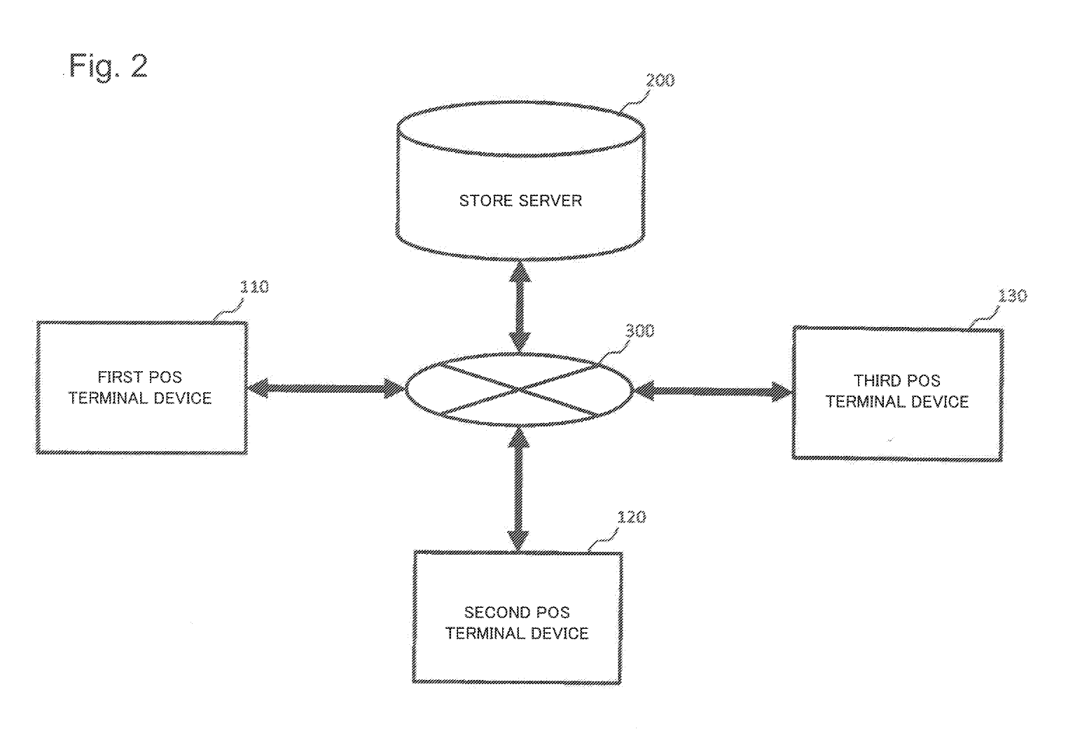

FIG. 2 is a schematic diagram illustrating how each POS terminal device and the server are connected. FIG. 2 illustrates an example in which the server 200 and three POS terminal devices are connected via a network 300, but this does not limit, e.g., the number of POS terminal devices connected to the server 200. The number of POS terminal devices connected to the server 200 can be set freely by the user. A method for transmitting and receiving subject information between each POS terminal device and a server will be explained with reference to FIG. 2.

As shown in FIG. 2, the server 200 is connected to a first POS terminal device 110, a second POS terminal device 120, a third POS terminal device 130 via the network 300.

The server 200 transmits and receives subject information to and from all of the three POS terminal devices via the network 300. The network 300 is, for example, the Internet. Therefore, in each of the first

POS terminal device 110 to the third POS terminal device 130, one of POS terminal devices can synchronize with the subject information transmitted from another POS terminal device to the server 200. Since the recognition rate is improved as the stored subject information increases in the first POS terminal device 110 to the third POS terminal device 130;

that is, a plurality of POS terminal devices are synchronized with one another, so that the recognition rate is further improved. Hereinafter, the processing executed by each POS terminal device and the processing in which each POS terminal device synchronizes the subject information with another POS terminal device will be explained in details.

### 3. Flow of Processing of POS Terminal Device

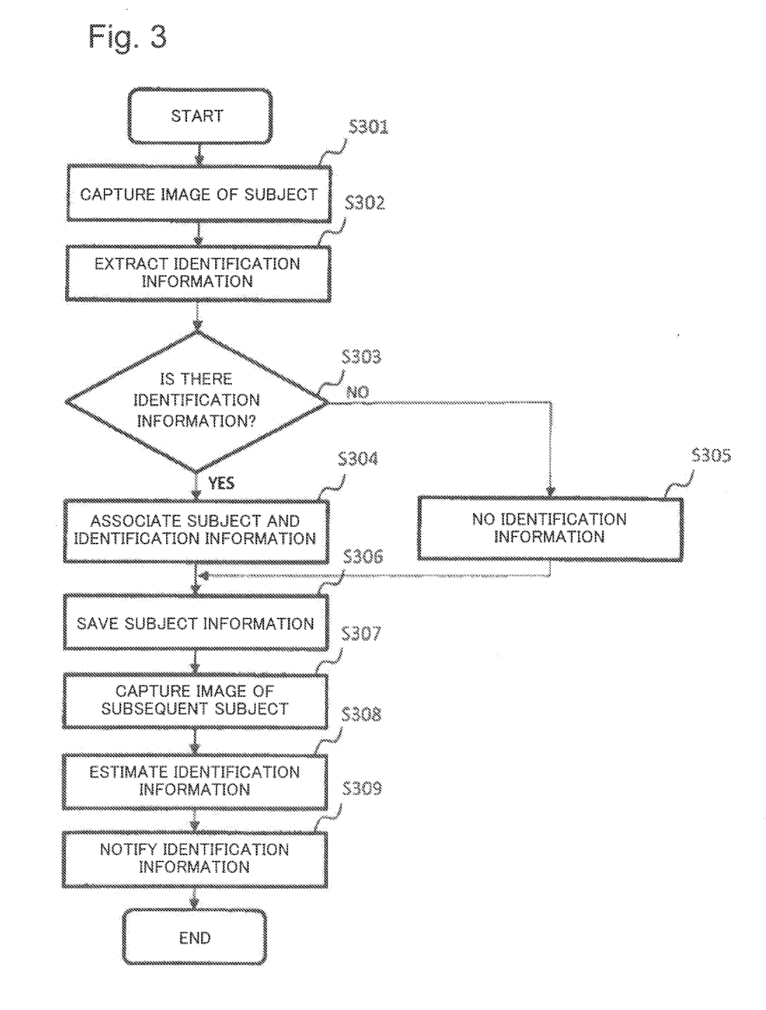

FIG. 3 is a flowchart illustrating a flow of processing executed by each unit of the POS terminal device 100. Hereinafter, the processing executed by the POS terminal device 100 according to the first exemplary embodiment of the present invention will be explained in details with reference to FIG. 3 and FIG. 1 as necessary.

First, the image capturing unit 102 captures an image of a product, and generates the image of the product captured (step S301). Subsequently, the image capturing unit 102 transmits the generated images of products to the identification information extraction unit 103 and the identification information estimation unit 104. Since the subject information does not exist when the image of the product received is obtained in the first image capturing process of the image capturing unit 102, the identification information estimation unit 104 cannot estimate the discount label adhered to the product on the basis of the image of the product received from the image capturing unit 102.

The identification information extraction unit 103 extracts the discount label adhered to the product from the image of the product received from the image capturing unit 102 (step S302). In this processing, the identification information extraction unit 103 first determines whether there is a discount label adhered to the product (step S303).

Subsequently, when the discount label is adhered to the product (“YES” in step S303), the identification information extraction unit 103 generates subject information in which the product and the discount label are associated with each other (step S304).

When any discount label is not adhered to the product (“NO” in step S303), the identification information extraction unit 103 generates subject information indicating that any discount label is not adhered to the product (step S305). More specifically, the identification information extraction unit 103 generates subject information regardless of whether there is a discount label adhered to the product.

Further, the identification information extraction unit 103 stores the generated subject information to the storage unit 105. At this occasion, the identification information extraction unit 103 may store the subject information to the server storage unit 210 via the communication unit 106 (step S306). At this occasion, for example, when any discount label is not adhered to the product that should originally have a discount label adhered thereto because of a reason, e.g., the discount label is accidently detached, it may possibly occurs in the identification information extraction unit 103 that it generates subject information, which is different from the original exact subject information, with regard to the product, and stores the subject information to the storage unit 105. However, even if the identification information extraction unit 103 generates the subject information different from the original subject information, the total number of pieces thereof is relatively less than the total number of pieces of correct subject information. As the identification information extraction unit 103 repeats generation of subject information about the same product, the total number of pieces of subject information different from the original subject information becomes relatively further less than the total number of pieces of correct subject information.

Subsequently, the image capturing unit 102 captures an image of a subsequent product, and generates the image of the product that has been captured (step S307). The processing in step S307 is the same as the processing in step S301, and the image capturing unit 102 captures an image of a product, and inputs the generated image into the identification information extraction unit 103 and the identification information estimation unit 104.

In this case, since the storage unit 105 and the server storage unit 210 stores the subject information, the identification information estimation unit 104 can estimate the discount label adhered to the product on the basis of the image of the product received from the image capturing unit 102. The processing performed by the identification information extraction unit 103 is the same as step S302 to step S306, and therefore, the explanation thereabout is omitted.

Subsequently, the identification information estimation unit 104 estimates the discount label associated with the product captured by the image capturing unit 102 on the basis of the subject information held by the storage unit 105 or the server storage unit 210 (step S308). At this occasion, in a case where there exist pieces of different subject information with reference to the product, the identification information extraction unit 104 estimates that subject information the total piece number of which is relatively large is the correct subject information about the product. The POS terminal devices are synchronized with each other concerning the subject information via the server 200, and therefore, the identification information estimation unit 104 can estimate the discount label associated with a product as long as the product has been captured by another POS terminal device even if the product is captured for the first time by the image capturing unit 102. Even if a captured image of a product shows a partial image of the product, and an image stored in the storage unit 105 or the server storage unit 210 is the entire image of the product, the identification information estimation unit 104 can estimate the discount label associated with the product. Likewise, even if a captured image of a product is the entire product and the image held by the server storage unit 210 is an image of a portion of the product, the identification information estimation unit 104 can estimate the discount label associated with the product.

If the identification information estimation unit 104 assumes that the discount label is associated with the product, the POS terminal device 100 notifies this to the operator and the like of the POS terminal device 100 (step S309). In a notification method, a message may be displayed on a display unit provided with the POS terminal device 100, or for example, the POS terminal device 100 may be further provided with an identification information notification unit, and a notification may be given by this identification information notification unit. For example, the identification information notification unit may be configured to allow the user to visually make a determination, or may be configured to generate a sound. Even in a case where a discount label has not been pasted to a product, the operator and the like of the POS terminal device 100 can recognize that the product is a discounted item by receiving a notification, and therefore, the operator and the like of the POS terminal device 100 can discount the price without making a mistake.

### 4. Other Exemplary Embodiment

### 4-1. Second Exemplary Embodiment

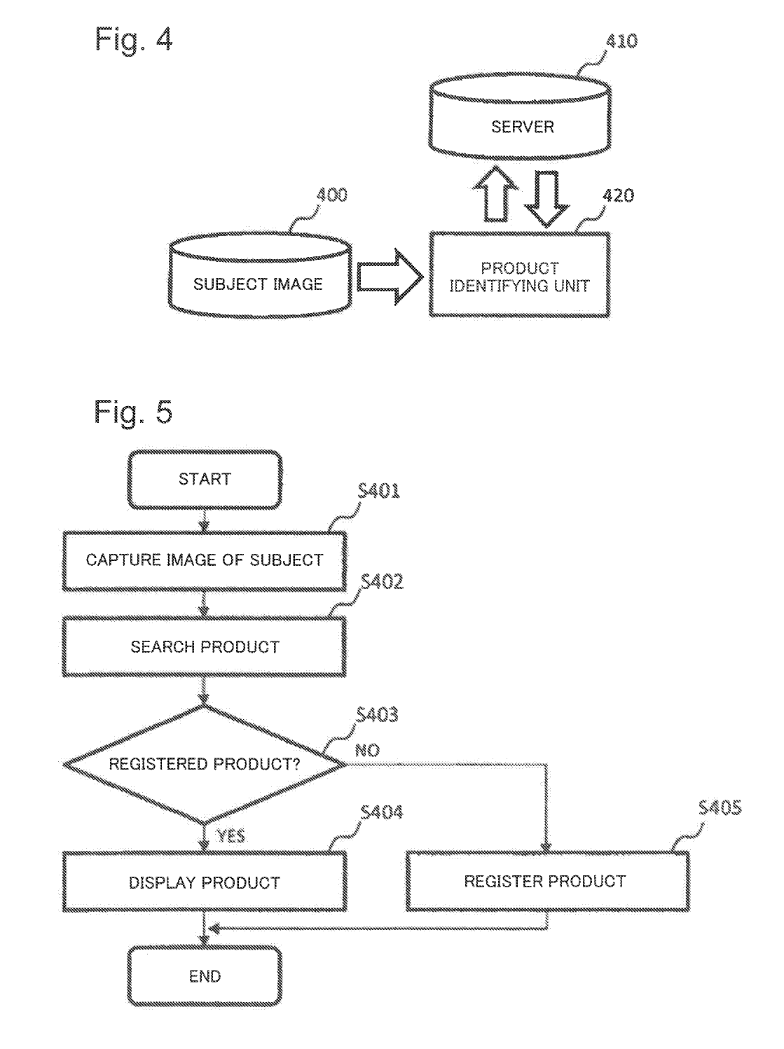

Subsequently, a POS terminal device according to a second exemplary embodiment of the present invention will be explained with reference to FIGS. 4 and 5.

The POS terminal device according to the second exemplary embodiment further includes a subject identifying unit capable of identifying a product the image of which has been captured in addition to the elements of the POS terminal device according to the first exemplary embodiment. This will be explained in a more specific manner. The POS terminal device according to the second exemplary embodiment is provided with a product identifying unit 420 that can estimate the discount label associated with the product and can identify a product the image of which has been captured. Although the POS terminal device according to the second exemplary embodiment will be explained, for example, the communication method and the like between the POS terminal device and the server is the same, except the product identifying unit 420, as those of the POS terminal device 100 according to the first exemplary embodiment, and therefore, explanation thereabout is omitted.

FIG. 4 is a schematic diagram illustrating how the product identifying unit 420 stores a subject image 400 into a server 410. FIG. 5 is a flowchart illustrating a flow of processing of the product identifying unit 420. Hereinafter, the product identifying unit 420 will be explained with reference to FIG. 1, FIG. 4 and FIG. 5 as necessary.

First, the product identifying unit 420 receives a subject image 400 (step S401). For example, in FIG. 1, the subject image 400 is an image of a product that has been captured and generated by the image capturing unit 102.

The product identifying unit 420 having received the subject image 400 searches the same image as the subject image 400 from the storage unit 105 and the server 410 (step S402). In a case where the same product as the subject image 400 is found from the storage unit 105 and the server 410 as a result of the search (“YES” in step S403), the product identifying unit 420 displays an identified product on a display unit and the like for displaying the product (step S404), and terminates the processing. In a case where the same product as the subject image 400 cannot be found from the storage unit 105 and the server 410 as a result of the search (“NO” in step S403), the product identifying unit 420 newly registers the product on the basis of the subject image 400 (step S405). In this case, the product identifying unit 420 registers the product to the server 410, so that information about the newly registered product can be shared by all the POS terminal devices connected to the server 410. As a result, even when another POS terminal device receives the subject image 400 at first, the another POS terminal device can determine that the product shown in the subject image 400 is a product that has been already received.

### 4-2. Third Exemplary Embodiment

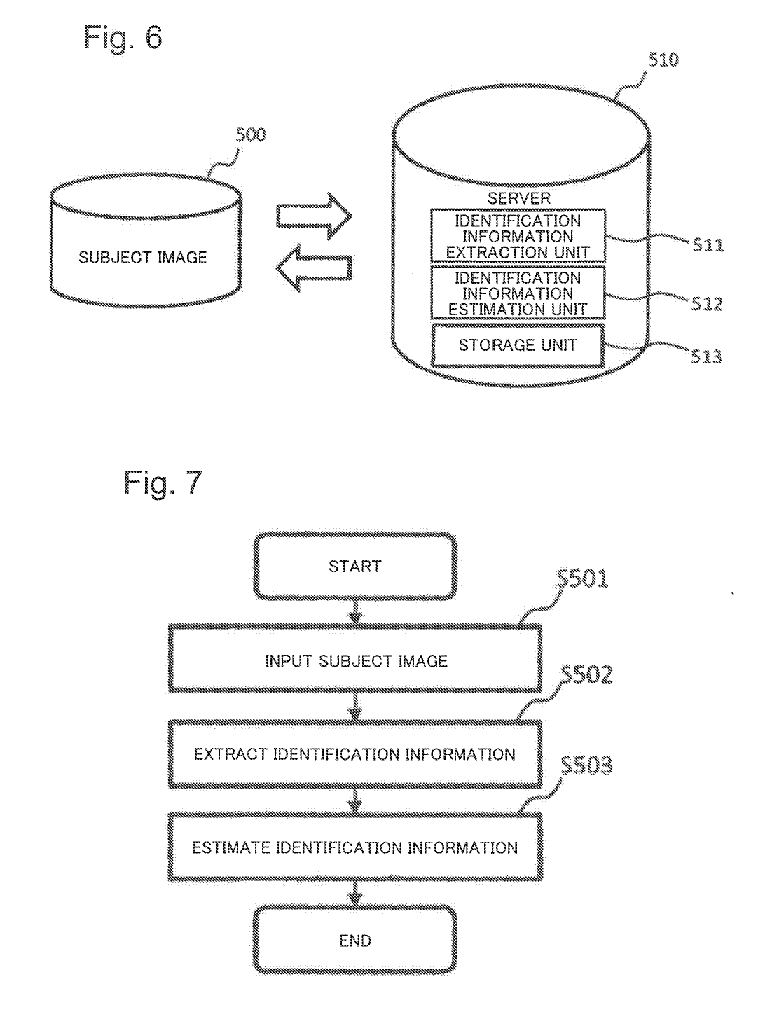

Subsequently, a POS terminal device according to the third exemplary embodiment will be explained with reference to FIG. 6.

The POS terminal device according to the third exemplary embodiment includes only an image capturing unit 102, and a server 510 includes an identification information extraction unit 511, an identification information estimation unit 512, and a storage unit 513. More specifically, the POS terminal device according to the third exemplary embodiment does not extract the identification information and estimate the identification information. Instead, the server 510 extracts the identification information and estimates the identification information.

The other functions, for example, the communication method between the POS terminal device and the server, are the same as those of the POS terminal device 100 according to the first exemplary embodiment, and therefore, explanation thereabout is omitted. A flow of processing of the POS terminal device according to the third exemplary embodiment will be hereinafter explained with reference to FIG. 7.

First, for example, in FIG. 1, the POS terminal device according to the third exemplary embodiment transmits the subject image 500 of the product captured and generated by the image capturing unit 102 to the server 510 (step S501). Subsequently, the server 510 having received the subject image 500 inputs the image of the product into the identification information extraction unit 511 and the identification information estimation unit 512. The identification information extraction unit 511 extracts the discount label from the subject image 500, and generates data in which the product and the extracted discount label are associated with each other (step S502). At this occasion, the identification information extraction unit 511 stores the data in which the product and the discount label are associated with each other into the storage unit 513.

Subsequently, the identification information estimation unit 512 estimates the discount label of the product associated with the captured product on the basis of the subject information held by the storage unit 513 (step S503).

Therefore, even in a mode in which the server 510 includes the identification information extraction unit 511 and the identification information estimation unit 512, the identification information can be estimated on the basis of the image of the product. The server 510 may further include the product identifying unit 420 provided in the POS terminal device according to the second exemplary embodiment.

### 4-3. Fourth Exemplary Embodiment

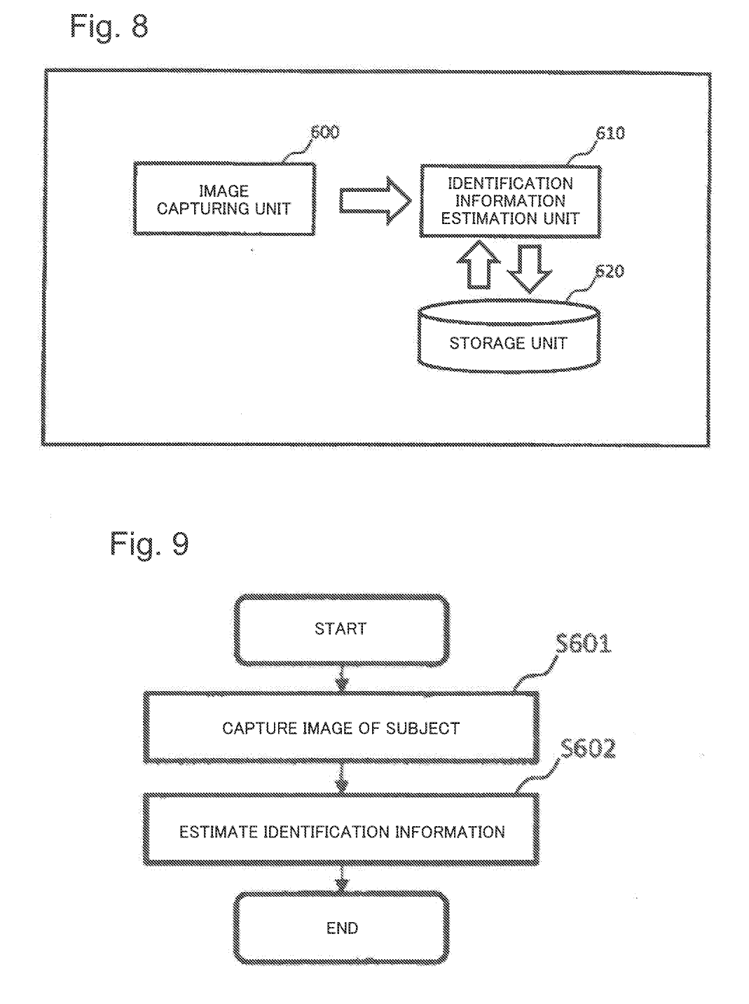

Subsequently, a POS terminal device made into a minimum configuration that does not have the function for communicating with the server will be explained as a POS terminal device according to the fourth exemplary embodiment with reference to FIGS. 8 and 9.

FIG. 8 is a block diagram illustrating a configuration of the POS terminal device according to the fourth exemplary embodiment. The POS terminal device according to the fourth exemplary embodiment includes an image capturing unit 600, an identification information estimation unit 610, and a storage unit 620.

FIG. 9 is a flowchart illustrating processing executed by the POS terminal device according to the fourth exemplary embodiment. Hereinafter, the processing executed by the POS terminal device according to the fourth exemplary embodiment will be explained with reference to FIG. 9.

The image capturing unit 600 captures an image of a product, and generates the image of the product (step S601). The image capturing unit 600 inputs the generated image into the identification information estimation unit 610.

Subsequently, the identification information estimation unit 610 estimates the discount label associated with the image of the product captured by the image capturing unit 600 on the basis of the subject information held by the storage unit 620 (step S602). More specifically, the POS terminal device according to the fourth exemplary embodiment is not synchronized with another POS terminal device, but can estimate the discount label associated with the product captured by the image capturing unit 600 on the basis of only the subject information held by the storage unit 620. In the POS terminal device according to the fourth exemplary embodiment, the recognition rate of the identification information estimation unit 610 is improved as the total number of pieces of subject information held by the storage unit 620 increases as a result of repeated use. Therefore, the POS terminal device according to the fourth exemplary embodiment can also achieve the same effects as the POS terminal device 100 according to the first exemplary embodiment.

In the above explanation, each unit provided in the POS terminal device according to the first exemplary embodiment to the fourth exemplary embodiment may be achieved by hardware, or may be achieved with software. Each unit may be achieved with a combination of hardware and software. For example, the computer may be caused to operate as the POS terminal device according to the first exemplary embodiment to the fourth exemplary embodiment by causing the control unit 101 to read a program held in the storage unit 105. The program may be held in a computer readable medium, and for example, the program may be held in a storage apparatus connected to a network.

### 5. Image Recognition Method

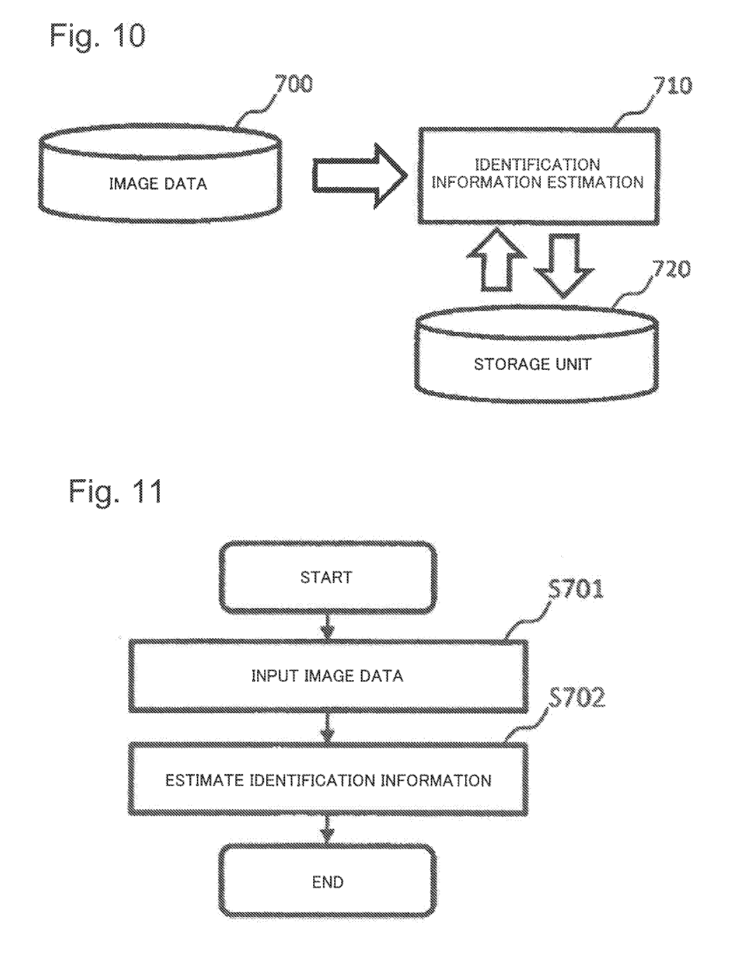

Subsequently, an image recognition method executed with a minimum configuration according to the present invention will be explained with reference to FIGS. 10 and 11.

FIG. 10 is a block diagram illustrating an image recognition according to the present invention. FIG. 11 is a flowchart illustrating a flow of the image recognition according to the present invention. Hereinafter, the image recognition method according to the present invention will be explained in details with reference to FIG. 10 and FIG. 11 as necessary.

In the image recognition method according to the present invention, first, an identification information estimation 710 is executed on image data 700 (step S701).

Subsequently, the identification information estimation 710 estimates identification information associated with the input image data 700. More specifically, the identification information estimation 710 searches the same image as the subject data 700 or an image similar thereto from the subject information held by the storage unit 720. At this occasion, the identification information estimation 710 can perform search even when the image data 700 is an image of a portion of the subject and even when the image held by the storage unit 720 is an image of the entire subject. Likewise, the identification information estimation 710 can perform search even when the image data 700 is an image of the entire subject and even when the image held by the storage unit 720 is an image of a portion of the subject.

The present invention has been hereinabove explained with reference to the exemplary embodiments, but the present invention is not limited to the above exemplary embodiments. The configuration and the details of the present invention can be changed in various manners that can be understood by a person skilled in the art within the scope of the present invention.

A portion or all of the above exemplary embodiments may also be described as follows. The following Supplementary Notes are not intended to limit the present invention in any manner.

### Supplementary Note 1

A POS terminal device including:

a storage unit storing subject information in which a subject and identification information are associated with each other;

an image capturing unit capturing an image of the subject and generating the image; and

an identification information estimation unit estimating, on the basis of the subject information, the identification information associated with the subject the image of which has been captured by the image capturing unit.

### Supplementary Note 2

The POS terminal device according to the Supplementary Note, further including an identification information extraction unit extracting the identification information from the image of the subject generated by the image capturing unit, and generating the subject information by associating the identification information with the subject and storing the subject information to the storage unit.

### Supplementary Note 3

The POS terminal device according to the Supplementary Note, further including an identification information notification unit notifying that the subject includes the identification information in a case where the identification information estimation unit estimates that the subject includes the identification information.

### Supplementary Note 4

The POS terminal device according to the Supplementary Note, wherein the identification information estimation unit estimates the identification information associated with the product on the basis of an image of at least a portion of the subject.

### Supplementary Note 5

The POS terminal device according to the Supplementary Note, further including a subject identifying unit identifying the product on the basis of the image of the subject captured by the image capturing unit.

### Supplementary Note 6

The POS terminal device according to the Supplementary Note, wherein the subject is a product bought and sold in a store.

### Supplementary Note 7

The POS terminal device according to the Supplementary Note, wherein the identification information is a mark indicating a discount of a product.

### Supplementary Note 8

An information processing apparatus including:

a storage unit storing subject information in which a subject and identification information are associated with each other; and

an identification information estimation unit receiving an image of the subject and estimating, on the basis of the subject information, the identification information associated with the subject.

### Supplementary Note 9

The information processing apparatus according to the Supplementary Note, further including an identification information extraction unit extracting the identification information from the image of the subject generated by the image capturing unit, and generating the subject information by associating the identification information with the subject and storing the subject information to the storage unit.

### Supplementary Note 10

An information processing system including:

the POS terminal device according to the Supplementary Note; and

an information processing apparatus,

wherein the POS terminal device further includes a communication unit transmitting and receiving the subject information to and from the information processing apparatus.

### Supplementary Note 11

The information processing system according to the Supplementary Note, wherein the POS terminal device synchronizes the subject information via the information processing apparatus with another POS terminal device.

### Supplementary Note 12

The information processing system according to the Supplementary Note, wherein the POS terminal device synchronizes the subject information held by another POS terminal device via the information processing apparatus.

### Supplementary Note 13

An information processing system including:

a POS terminal device including an image capturing unit capturing an image of a subject and generating the image; and

an information processing apparatus,

wherein the information processing apparatus includes:

a storage unit storing subject information in which the subject and identification information are associated with each other; and

an identification information estimation unit estimating, on the basis of the subject information, the identification information associated with the subject the image of which has been captured by the image capturing unit.

### Supplementary Note 14

The information processing system according to the Supplementary Note, wherein the information processing apparatus further includes an identification information extraction unit extracting the identification information from the image of the subject, generating the subject information by associating the identification information with the subject and storing the subject information to the storage unit.

### Supplementary Note 15

An image recognition method including:

capturing an image of a subject and generating the image; and

estimating, on the basis of subject information held by a storage unit, identification information associated with the subject the image of which has been captured.

### Supplementary Note 16

The image recognition method according to the Supplementary Note, wherein the identification information is extracted from the image of the subject that has been captured, and the subject information is generated by associating the identification information with the subject, and the subject information is stored to the storage unit.

### Supplementary Note 17

The image recognition method according to the Supplementary Note, wherein it is notified that the product includes the identification information in a case where it is estimated that the subject includes the identification information.

### Supplementary Note 18

The image recognition method according to the Supplementary Note, wherein the identification information associated with the product is estimated on the basis of an image of at least a portion of the subject.

### Supplementary Note 19

The image recognition method according to the Supplementary Note, wherein the subject is identified on the basis of the image of the subject.

### Supplementary Note 20

The image recognition method according to the Supplementary Note, wherein the subject is a product bought and sold in a store.

### Supplementary Note 21

The image recognition method according to the Supplementary Note, wherein the identification information is a mark indicating a discount of a product.

### Supplementary Note 22

An image recognition program causing a computer to operate as:

storage means storing subject information in which a subject and identification information are associated with each other;

image capturing means capturing an image of the subject and generating the image; and

identification information estimation means estimating, on the basis of the subject information, the identification information associated with the subject the image of which has been captured by the image capturing unit.

### Supplementary Note 23

The image recognition program according to the Supplementary Note, causing the computer to further operate as identification information extraction means extracting the identification information from the image of the subject generated by the image capturing unit, and generating the subject information by associating the identification information with the subject and storing the subject information to the storage unit.

### Supplementary Note 24

The image recognition program according to the Supplementary Note, causing the computer to further operate as notification means notifying that the subject includes the identification information in a case where the identification information estimation unit estimates that the subject includes the identification information.

### Supplementary Note 25

The image recognition program according to the Supplementary Note, causing the computer to further estimate the identification information associated with the product on the basis of an image of at least a portion of the subject.

### Supplementary Note 26

The image recognition program according to the Supplementary Note, causing the computer to further operate as a product identifying unit identifying the product on the basis of the image of the subject.

### Supplementary Note 27

The image recognition program according to the Supplementary Note, wherein the subject is a product bought and sold in a store.

### Supplementary Note 28

The image recognition program according to the Supplementary Note, wherein the identification information is a mark indicating a discount of a product.

This application claims the priority based on Japanese Patent Application No. 2014-065285 filed on Mar. 27, 2014, and the entire disclosure thereof is incorporated herein by reference.

### REFERENCE SIGNS LIST

100 . . . POS terminal device
101 . . . control unit
102 . . . image capturing unit
103 . . . identification information extraction unit
104 . . . identification information estimation unit
105 . . . storage unit
106 . . . communication unit
110 . . . first POS terminal device
120 . . . second POS terminal device
130 . . . third POS terminal device
200 . . . server
210 . . . server storage unit
300 . . . network
400 . . . subject image
410 . . . server
420 . . . product identifying unit
500 . . . subject image
510 . . . server
511 . . . identification information extraction unit
512 . . . identification information estimation unit
513 . . . storage unit
600 . . . image capturing unit
610 . . . identification information estimation unit
620 . . . storage unit
700 . . . image data
710 . . . identification information estimation
720 . . . storage unit

1. A POS (Point Of Sales) terminal device comprising:
a storage unit that stores subject information in which a subject and identification information are associated with each other;
an image capturing unit that captures an image of the subject and generates the image; and
an identification information estimation unit that estimates, based on the subject information, the identification information associated with the subject the image of which has been captured by the image capturing unit.

2. The POS terminal device according to claim 1, further comprising an identification information extraction unit that is extracts the identification information from the image of the subject generated by the image capturing unit, and generates the subject information by associating the identification information with the subject and storing the subject information to the storage unit.

3. The POS terminal device according to claim 1 or 2, further comprising an identification information notification unit that notifies that the product includes the identification information when the identification information estimation unit estimates that the subject includes the identification information.

4. The POS terminal device according to claim 1, wherein the identification information estimation unit estimates the identification information associated with the subject based on an image of at least a portion of the subject.

5. The POS terminal device according to claim 1, further comprising a subject identifying unit that identifies the subject based on the image of the subject captured by the image capturing unit.

6. The POS terminal device according to claim 1, wherein the subject is a product bought and sold in a store.

7. The POS terminal device according to claim 1, wherein the identification information is a mark indicating a discount of a product.

8. An information processing apparatus comprising:
a storage unit that stores subject information in which a subject and identification information are associated with each other; and
an identification information estimation unit that receives an image of the subject and estimating, based on the subject information, the identification information associated with the subject.

9. An information processing system comprising:
the POS terminal device according to claim 1; and
an information processing apparatus,
wherein the POS terminal device further includes a communication unit that transmits and receives the subject information to and from the information processing apparatus.

10. An information processing system comprising:
a POS terminal device that includes an image capturing unit capturing an image of a subject and generating the image; and
an information processing apparatus,
wherein the information processing apparatus includes:
a storage unit that stores subject information in which the subject and identification information are associated with each other; and
an identification information estimation unit that estimates, based on the subject information, the identification information associated with the subject the image of which has been captured by the image capturing unit.

11. An image recognition method comprising:
capturing an image of a subject and generating the image; and
estimating, based on subject information held by a storage unit, identification information associated with the subject the image of which has been captured.

12. A computer-readable storage medium storing an image recognition program causing a computer to operate as:
storage means for storing subject information in which a subject and identification information are associated with each other;
image capturing means for capturing an image of the subject and generating the image; and
identification information estimation means for estimating, on the basis of the subject information, the identification information associated with the subject the image of which has been captured by the image capturing unit.
